(19) United States
(12) Patent Application Publication
(10) Pub. No.: US 2011/0296165 A1
(43) Pub. Date: Dec. 1, 2011

(54) INFORMATION PROCESSING APPARATUS, TRANSMISSION INFORMATION ENCRYPTION METHOD, AND TRANSMISSION INFORMATION ENCRYPTION PROGRAM

(76) Inventors: Junko Suginaka, Tokyo (JP); Yoshihisa Furukawa, Tokyo (JP)

(21) Appl. No.: 13/138,391

(22) PCT Filed: Feb. 25, 2009
(86) PCT No.: PCT/JP2009/053366

§ 371 Date: Aug. 10, 2011

(51) Int. Cl. H04L 9/28

(52) U.S. Cl. 713/150

(57) ABSTRACT

An information processing apparatus of the invention includes a virtual geometric structure (7) including a virtual three-dimensional body having n cubes in each axis direction, each cube rotatable about a central axis in each axis direction with an initial address set in each cube prior to rotation, the initial address being successively shifted in a spiral fashion in response to the rotation of the cube about the central axis, an address conversion unit (3021) for rotating the virtual geometric structure (7) successively about each of the central axes in accordance with a predetermined scrambling rule with a pitch of an integer multiple of ¼(n−1) and calculating a final address responsive to each of the initial addresses subsequent to the shifting, an information segmentation unit (3022) for segmenting transmission target information into a plurality of information units, and a scrambling unit (3023) for re-arranging, prior to the transmission, a sequence of the information units in accordance with the order of the final addresses, instead of the initial addresses assigned prior to the rotation.

### TECHNICAL FIELD

The present invention relates to an information processing apparatus for transmitting encrypted information via a network, and an encryption technique.

### BACKGROUND ART

Information transmitted from an information processing apparatus such as a personal computer or a server to another information processing apparatus via a network such as the Internet is segmented into packets of predetermined bits in accordance with a predetermined transmission protocol. The packet is subject to secret leak because a third party can capture the packet using a packet capturing function. In a security system which is in widespread use today to ensure security of information transmitted via the network, a plain-text file is encrypted as a transmission target and then transmitted, and a information terminal as a receiver side decrypts the received file to the original plain text. A system using a common key and a system using a public key are known as a security system. The common key cryptosystem has a problem with secrecy about the transmission of a key itself. In the public key cryptosystem, on the other hand, a file encrypted with a public key can be decrypted with only a secret key of the information terminal at the receiver side. From the standpoint of secrecy, the public key cryptosystem is preferable. An expiration date for use is set on the public key, or a method of attaching a certificate to the public key is used. However in these cases, a third party may enter the public key before the expiration date, or identify fraud may be performed to a certifying authority. As a result, the effectiveness of these steps is still limited.

A transposition cipher is known as a cryptosystem handled by a computer. In the transposition cipher, a sentence basically formed of a character or a word is transposed in a sequence different from the sentence. Patent Document 1 describes a transmission apparatus employing the transposition cipher. The transmission apparatus includes an application supplying plain-text data, an N-dimensional sequencer for sequencing the plain-test data in an N dimension, a sequence shifting unit for performing a predetermined shift process on the N-dimensionally arranged plain-text data, an encryption unit for encrypting the sequence-shifted plain-text data, and a transmitter for transmitting the encrypted sentence to a receiver.
[Patent Document 1] Japanese Unexamined Patent Application Publication No. 2008-252349

### DISCLOSURE OF INVENTION

### Problems to be solved by the Invention

In accordance with the transposition method described in Patent Document 1, the plain-text data is sequenced into data in the N dimension, and then shifted by a predetermined pitch in each sequencing direction. Information is definitely discontinued (scrambled) at a boundary of shifts but information remains continued in a relatively wide region in each dimension direction. In accordance with Patent Document 1, an exclusive OR gating operation is performed on a bit train to heighten the level of secrecy.

The object of the invention is to provide an information processing apparatus, a transmission information encryption method and a transmission information encryption program for encrypting information simply and easily, through imparting a rotation to a three-dimensional geometric structure about each axis to scramble an address of each element via calculation, and through segmenting transmission target information and re-arranging the segmented transmission information in accordance with the results of scrambling at transmission.

### Means for Solving the Problems

An information processing apparatus of the invention for transmitting encrypted information via a network, includes a virtual geometric structure including a virtual three-dimensional body having n tiers of elements in each axis direction, each element rotatable about a central axis in each axis direction with an initial address set in each element prior to rotation, the initial address being successively shifted in a spiral fashion in response to the rotation of the element about the central axis, an address conversion unit for rotating the virtual geometric structure successively about each of the central axes in accordance with a predetermined scrambling rule with a pitch of an integer multiple of ¼(n−1) and calculating a final address responsive to each of the initial addresses subsequent to the shifting, an information segmentation unit for segmenting transmission target information into a plurality of information units, and a scrambling unit for re-arranging, prior to the transmission, a sequence of the information units in accordance with the order of the final addresses, instead of the initial addresses assigned prior to the rotation.

A transmission information encryption method of the invention for encrypting information to be transmitted via a network, includes a step of preparing a virtual geometric structure including a virtual three-dimensional body having n tiers of elements in each axis direction, each element rotatable about a central axis in each axis direction with an initial address set in each element prior to rotation, the initial address being successively shifted in a spiral fashion in response to the rotation of the element about the central axis, a step of address conversion for rotating the virtual geometric structure successively about each of the central axes in accordance with a predetermined scrambling rule with a pitch of an integer multiple of ¼(n−1) and calculating a final address responsive to each of the initial addresses subsequent to the shifting, a step of information segmentation for segmenting transmission target information into a plurality of information units, and a step of scrambling for re-arranging, prior to the transmission, a sequence of the information units in accordance with the order of the final addresses, instead of the initial addresses assigned prior to the rotation.

A transmission information encryption program for causing a computer to encrypt information to be transmitted via a network, the program causing the computer to operate as: address conversion unit for rotating a virtual geometric structure successively about each central axis in accordance with a predetermined scrambling rule with a pitch of an integer multiple of ¼(n−1) and calculating a final address responsive to each initial address subsequent to shifting, the virtual geometric structure including a virtual three-dimensional body having n tiers of elements in each axis direction, each element rotatable about a central axis in each axis direction with an initial address set in each element prior to rotation, the initial address being successively shifted in a spiral fashion in response to the rotation of the element about the central axis; segmentation unit for segmenting transmission target information into a plurality of information units; and scrambling unit for re-arranging, prior to transmission, a sequence of the information units in accordance with the order of the final addresses, instead of the initial addresses assigned prior to the rotation.

### Advantages

According to the invention, an address as a scrambling target is scrambled through calculation, and transmission target information is segmented and re-arranged in accordance with scrambling results at transmission of the transmission target. The transmission target information is thus simply and easily encrypted.

### BRIEF DESCRIPTION OF THE DRAWINGS

FIG. 1 generally illustrates a configuration of a network system to which an information processing apparatus of the invention is applied.

FIG. 2 is a function block diagram of a member terminal 1.

FIG. 3 is a functional block diagram of a management server 3.

FIG. 4A illustrate the principle of an encryption process performed using a geometric structure with n being 3, showing information units into which plain text as an encryption target is segmented. FIG. 4B illustrate the principle of an encryption process performed using a geometric structure with n being 3, showing a relationship between the information units D and addresses of cubes Cu forming the geometric structure.

FIG. 5 illustrates a rotation of the geometric structure about each axis.

FIG. 6 illustrates shift characteristics of the addresses of the cubes Cu that shift in response to the rotation of the geometric structure.

FIG. 7 is a flowchart of a startup process executed by a controller 30 in a management server 3.

FIG. 8 is a flowchart of a startup process executed by a controller 100 in a terminal 1.

FIG. 9A illustrate shift characteristics of the addresses of the cubes that shift in response to the rotation of the cube in another embodiment, showing the shift characteristics with n being 5. FIG. 9B illustrate shift characteristics of the addresses of the cubes that shift in response to the rotation of the cube in another embodiment, showing the shift characteristics with n being 6.

### EXPLANATION OF REFERENCE NUMBERS

1 Member terminal
2 Banking institution terminal
3 Management institution server
6 dedicated network
7 Geometric structure (virtual geometric structure)
10 Modem (information processing apparatus)
100 Controller
101 Communication control unit
102 Startup processor unit
103 Decryption processor unit
104 Image display control unit
105 File production processor unit
110 Storage
111 File storage unit
112 Screen image storage unit
113 Startup program storage unit
114 Control program storage unit
30 Controller
301 Communication control unit
302 Encryption processor
3021 Address conversion unit (address conversion unit)
3022 Information segmentation unit (information segmentation unit)
3023 Scrambling unit (scrambling unit)
3024 Size adjusting unit (size adjusting unit)
3025 Key information attaching unit (key attaching unit)
303 Information processor
31 Storage
311 Member information storage unit
312 Communication file storage unit
313 Encryption program storage unit
314 Control program storage unit
A, B, and C Rotation axes
D1-D27 Information units
Cu1-Cu27 Cubes

### BEST MODE FOR CARRYING OUT THE INVENTION

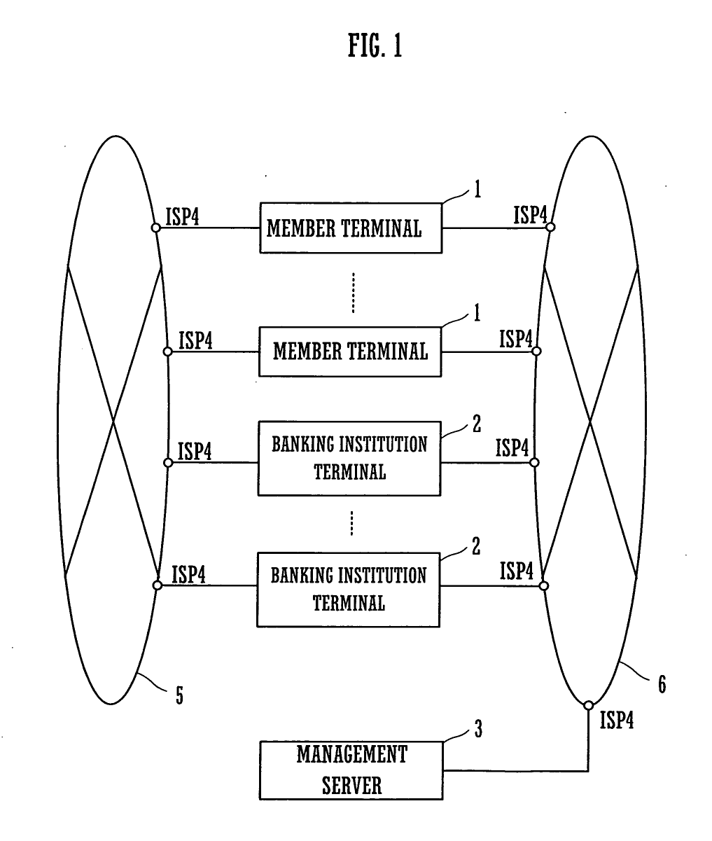

FIG. 1 generally illustrates an example of a network system to which an information processing apparatus of the invention is applied. The network system illustrated in FIG. 1 includes member terminals 1 for consumers, member terminals 1 installed at stores, companies, and the like, and banking institution terminals 2 installed at least one banking institution, such as banks. The terminals 1 and 2 are connected to the network via a provider (ISP) 4. The network system includes the Internet 5, and a dedicated network 6 different from the Internet 5. A consumer, a store, a company and a banking institution, becoming a member of an established organization, are granted a right (access right) to be connected to the dedicated network 6. The member can thus exchange information with another member via the dedicated network 6. As illustrated in FIG. 1, different providers ISP 4 are illustrated for the Internet 5 and the dedicated network 6, but the providers ISP 4 may be shared by the Internet 5 and the dedicated network 6. It is sufficient if the terminals 1 and 2 are connected to the dedicated network 6. The terminals 1 and 2 are not necessarily connected to the Internet 5.

The management server 3 is managed and operated by the established organization or a supervisor who is entrusted by the organization. The management server 3 includes a computer and a storage, and is connected to the dedicated network 6. The management server 3 is installed at a management institution that exchanges information with the terminals 1 and 2, and generally manages and stores information. In one embodiment, the management server 3 may be installed at one of the providers ISP 4.

More specifically, the dedicated network 6 assists in electronic payment or the like among members registered in the established organization. For example, the dedicated network 6 assists in settlement in general business transactions, including the writing or receiving of a bill by a shop owner, a directive for transferring (i.e., payment of) money from a purchaser to an account in a bill issuer's banking institution, and issuance of a receipt of the directive. The dedicated network 6 exchanges a variety of digital documents in not only electronic payment but also business transactions. The terminals 1 and 2 produce a variety of documents as an electronic file. The electronic file may be exchanged among the terminals 1 and 1, or the terminals 1 and 2 via the management server 3.

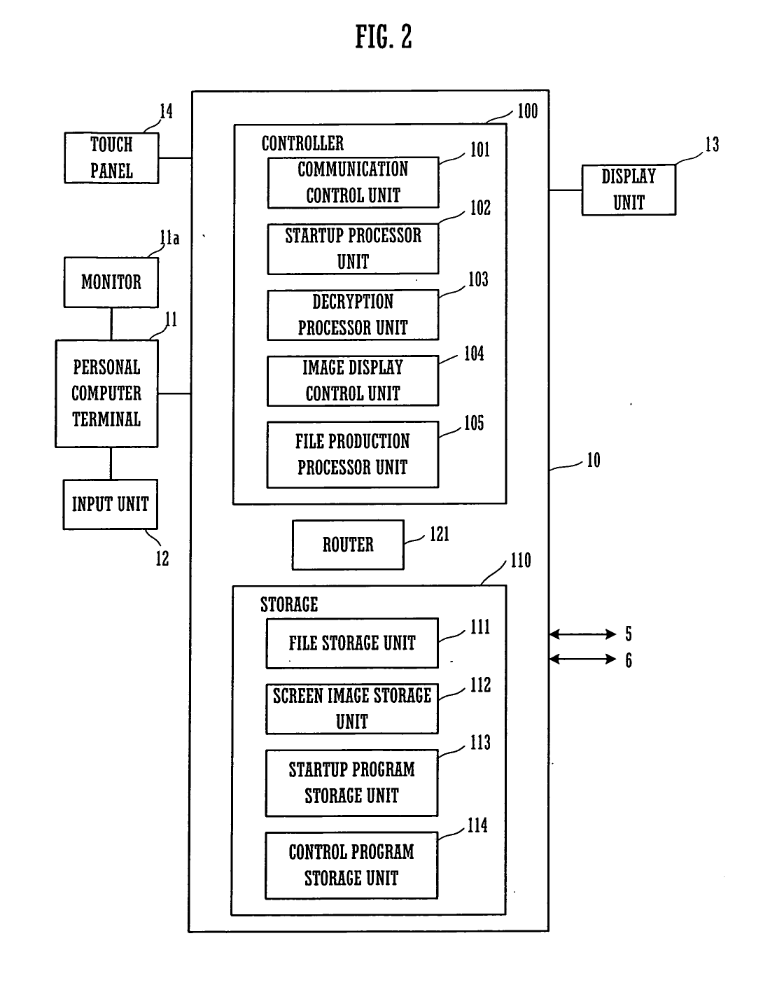

FIG. 2 is a function block diagram of the member terminal 1. As illustrated in FIG. 2, the member terminal 1 includes a modem 10 (information processing device) connected to the provider ISP 4. As necessary, the member terminal 1 includes, as means for auxiliary producing or viewing a file, a personal computer (hereinafter referred to as a personal computer terminal) 11 and an input unit 12. The personal computer terminal 11 is connected to the modem 10 and includes a monitor 11a having a liquid-crystal display or the like. The input unit 12 is connected to the personal computer terminal 11, and includes a mouse and a keyboard for inputting information, and placing an instruction to display and process information.

The modem 10 has a predetermined shape, such as of a rectangular parallelepiped casing, and includes a modulator and a demodulator for performing an intended function. The modem 10 also has input and output wiring terminals on an appropriate location on the surface thereof. The modulator modulates information, generated by the personal computer terminal 11 and also generated by the modem 10 as described below, to a signal in a form that that permits the signal to be transferred along one of the Internet 5 or the dedicated network 6. The demodulator demodulates a signal received via one of the Internet 5 or the dedicated network 6 to a signal in a form that permits the signal to be processed by one of the modem 10 or the personal computer terminal 11.

The modem 10 includes a display unit 13 and a touchpanel 14 on an appropriate location on the surface thereof. The display unit 13 having a liquid-crystal display panel or a plasma display panel displays an image. The touchpanel 14 is laminated on top of the display unit 13. The touchpanel 14 may be one of known electrical, ultrasonic, optical, and pressure-sensitive elements. On each image (such as a button) displayed on the display unit 13, the storage 110 to be discussed later pre-stores a display position of the image and coordinates of a pressing operation position on the touchpanel 14 mapped to the display position. The information about a press detection position thus serves to identify which button image displayed on the display unit 13 has been selected.

The modem 10 further includes a controller 100 having a CPU (Central Processing Unit) and the storage 110 (ROM and RAM). The controller 100 executes a program stored on the storage 110. The controller 100 thus functions as communication control unit 101, startup processor unit 102, decryption processor unit 103, image display control unit 104, and file production processor unit 105.

The storage 110 includes file storage unit 111, screen image storage unit 112, startup program storage unit 113, and control program storage unit 114. The storage 110 stores a startup program on the ROM area thereof. In one embodiment, a control program (application program) for a digital file produced by the modem 10 and the transmission and reception of the digital file is installed from the management server 3 onto the storage 110. The control program is installed at the power-on of the modem 10, and uninstalled at the power-off of the modem 10. In this way, the secrecy of the control program is ensured as much as possible even if the modem 10 is stolen.

The communication control unit 101 performs a process of a controller (not illustrated) of a router 121. The communication control unit 101 sorts (routes) files to be transmitted, the files being those from the personal computer terminal 11, or those produced by the touchpanel 14 and the controller 100 in the modem 10, to the Internet 5 or to the dedicated network 6 as a packet signal having a predetermined format. The communication control unit 101 also routes an incoming packet signal from the outside to the model 10 or the personal computer terminal 11. The communication control unit 101 also performs a process to identify address information representing a transmission destination attached to a predetermined position of each packet as a transmission signal or a reception signal. More specifically, the communication control unit 101 determines whether the address information indicates a global IP address defined by the standard of the Internet 5, or a predetermined local IP address for the dedicated network 6, for example, complying with the Ethernet (registered trademark) or the like different from the global IP address in the concatenation method (the predetermined local IP address being discriminated from the global IP address in format).

With the modem 10 powered on, the startup processor unit 102 reads the startup program from the startup program storage unit 113 and starts up the modem 10. The startup processor unit 102 outputs to the management server 3 a transmission request signal for the control program, receives an encrypted control program, and executes a predetermined startup process including a decryption process to be discussed below. As described below, the management server 3 encrypts the control program and transmits the encrypted control program to the member terminal 1 having placed the transmission request. The management server 3 also attaches a decryption rule (key) to a header region of a predetermined packet.

The decryption processor unit 103 decrypts the encrypted control program received by the startup processor unit 102. The control program includes a plurality of packets. The decryption processor unit 103 acquires the scrambling rule corresponding to the decryption rule attached to a header area of a predetermined packet out of the plurality of packets forming the control program, and performs a decryption process on the control program using the scrambling rule. A decrypted control program is written on the control program storage unit 114.

The image display control unit 104 causes the display unit 13 to display a produced file and a received file. The image display control unit 104 displays a variety of button images assisting in file production, and executes a display process responsive to a button specified via the touchpanel 14. The file production processor unit 105 assists the user who may produce a file such as the above-described bill using the touchpanel 14.

The banking institution terminal 2, which is not discussed in detail, is intended to digitally perform settlement of transactions among members. The banking institution terminal 2 includes a controller as a computer performing a settlement process, and a storage storing settlement contents as a history.

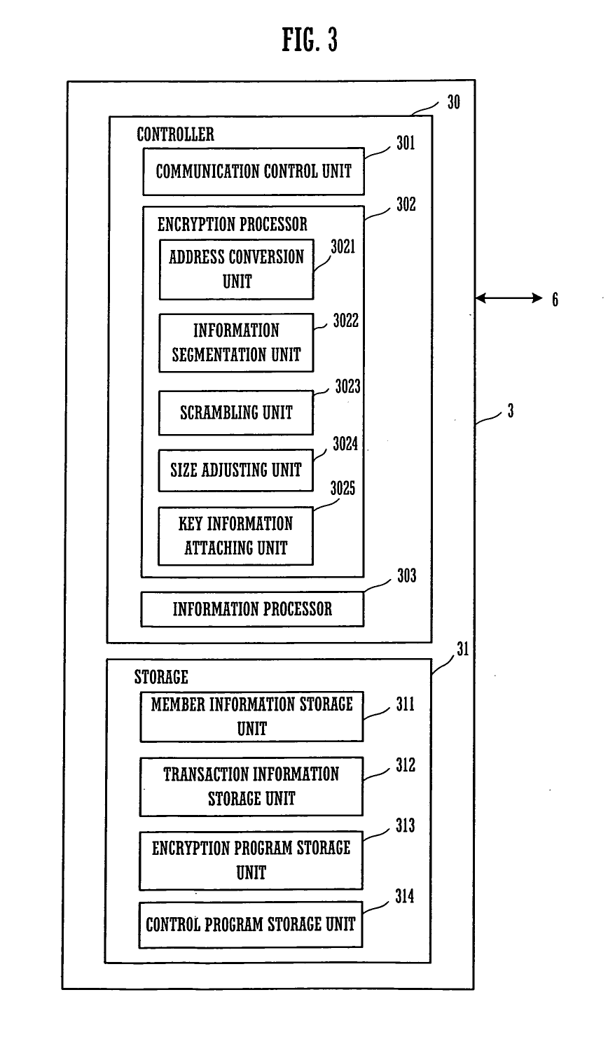

FIG. 3 is a function block diagram of the management server 3. As illustrated in FIG. 3, the management server 3 includes at least a controller 30, including a CPU, and a storage 31. The controller 30 executes the program stored on the storage 31, and thus functions as communication control unit 301, encryption processor 302, and information processor 303. The storage 31 includes member information storage unit 311, transaction information storage unit 312, encryption program storage unit 313, and control program storage unit 314.

The communication control unit 301 relays information (such as a file) between the member terminals 1 and 1, and between the member terminal 1 and the banking institution terminal 2. When a file is exchanged between members, the management server 3 receives the file. The information processor 303 in the management server 3 stores the files on the transaction information storage unit 312 chronologically on a per member basis.

Upon receiving a transmission request signal from the member terminal 1, the communication control unit 301 transmits the control program encrypted by the encryption processor 302 to the member terminal 1 having placed the transmission request.

The encryption processor 302 encrypts the control program, stored on the control program storage unit 314, in accordance with an encryption program stored on the encryption program storage unit 313. The encryption processor 302 includes address conversion unit 3021, information segmentation unit 3022, scrambling unit 3023, size adjusting unit 3024, and key information attaching unit 3025. The address conversion unit 3021 calculates an address (shift address) after a cube Cu shifts in response to a rotation of a virtual geometric structure 7 to be discussed later. The information segmentation unit 3022 segments encryption target (transmission target) information into predetermined information units. The scrambling unit 3023 re-arranges (scrambles) segmented information units in accordance with a shift address. The size adjusting unit 3024 generates the virtual geometric structure 7 responsive to the number of information units. The key information attaching unit 3025 adds decrypted information to a header area of a transmission packet.

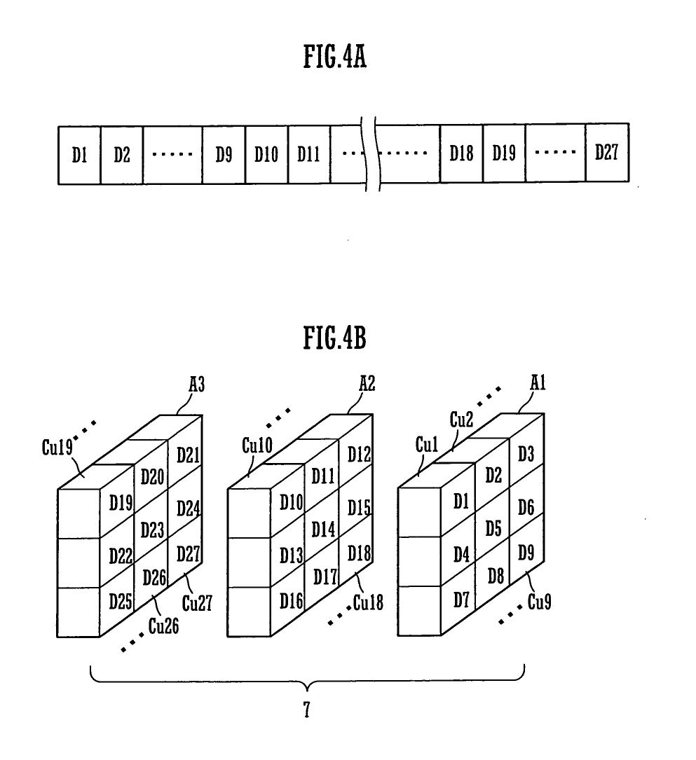

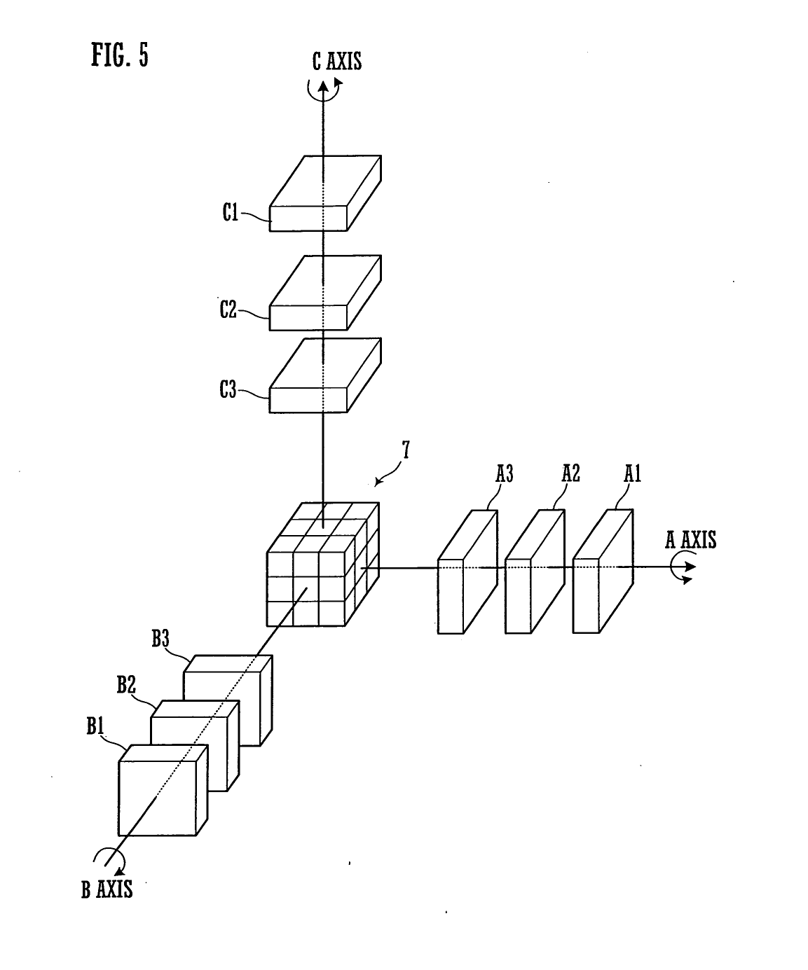

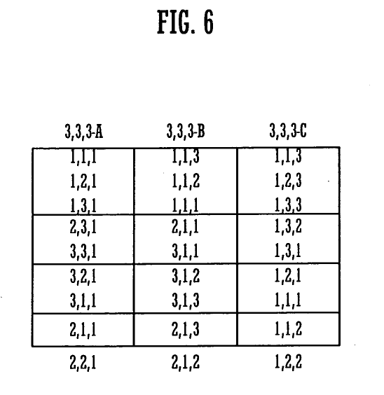

FIGS. 4-6 illustrate the principle of the encryption process performed using the geometric structure. FIG. 4A illustrates information units into which plain text as an encryption target is segmented, and FIG. 4B illustrates a relationship between each information unit D and the address of each cube Cu forming the geometric structure. FIG. 5 illustrates a rotation of the geometric structure about each axis. FIG. 6 illustrates shift characteristics of addresses of the cubes Cu that shift in response to the rotation of the geometric structure. In the above discussion, elements forming the virtual geometric structure 7 are described as a rectangular parallelepiped because the vision of the cube enhances ease of understanding. The shape of the element is not important, and the arrangement of the elements is important.

According to the embodiment, the management server 3 encrypts the control program and transmits the encrypted control program to the member terminal 1. The invention is not limited to this embodiment. A file exchanged between the management server 3 and the member terminal 1, between the member terminals 1 and 1, or between the member terminals 1 and 2 may also be encrypted.

In the embodiment, the virtual geometric structure 7 has three cubes (elements) Cu arranged in each of the three axes. As illustrated in FIG. 5, each cube Cu rotates about each of the three axes, i.e., A axis, B axis, and C axis. If viewed from the A axis, a first tier A1, a second tier A2, and a third tier A3 individually rotate about the A axis. If viewed from the B axis, a first tier B1, a second tier B2, and a third tier B3 individually rotate about the B axis. If viewed from the C axis, a first tier C1, a second tier C2, and a third tier C3 individually rotate about the C axis. Each of the axes agrees with a normal line to the center cube Cu.

As illustrated in FIG. 4B, cubes Cu1-Cu27 identify positions thereof within the virtual geometric structure 7 of the cubes. The cubes Cu1-Cu27 are mapped to addresses of the cubes in response to the rotation of the virtual geometric structure 7. The addresses are described in a fixed format as (C axis direction, B axis direction, C axis direction)=(1,1,1)-(3,3,3).

FIG. 4B illustrates the first tier A1, the second tier A2, and the third tier A3 viewed from the A axis, and the addresses of the cubes Cu1-Cu27 are represented as (1,1,1)-(3,3,3). More specifically, cubes Cu1-Cu9 expanding from the left end on the first row to the right end on the third row of the first tier A1 respectively correspond to (1,1,1)-(3,3,1). Cubes Cu10-Cu18 expanding from the left end on the first row to the right end on the third row of the second tier A2 respectively correspond to (1,1,2)-(3,3,2). Cubes Cu19-Cu27 expanding from the left end on the first row to the right end on the third row of the third tier A3 respectively correspond to (1,1,3)-(3,3,3). Plain text of FIG. 4A prior to encryption is segmented into information units D1-D27 every predetermined bits. The information units D1-D27 are assigned to the cubes Cu1-Cu27 as illustrated in FIG. 4B.

The information reading is performed in the order of addresses (1,1,1) . . . (3,3,1), (1,1,2) . . . (3,3,2), (1,1,3) . . . (3,3,3). In the state of the virtual geometric structure 7 prior to the rotation, the cubes Cu1-Cu27 match the addresses thereof, in other words, information units D1-D27 match the addresses thereof in arrangement. If the virtual geometric structure 7 remains unrotated, the information units D are read in the order of D1-D27 (in other words not scrambled).

If the virtual geometric structure 7 rotates in any order of the A axis—the C axis, the mapping relationship between the cubes Cu and the addresses is modified. The rotation of the virtual geometric structure 7 about each axis is performed in a spiral-like shifting fashion, in which the addresses of the cubes Cu of the embodiment are successively shifted about each rotation axis from outer cube to inner cube. For example, FIG. 6 illustrates three digit numbers, which are shifted as addresses of the cubes Cu about each of the A axis, the B axis, and the C axis.

In the first tier A1 about the axis A, (1,1,1) is mapped to the cube Cu1, (1,2,1) is mapped to the cube Cu2, (1,3,1) is mapped to the cube Cu3, (2,3,1) is mapped to the cube Cu6, (3,3,1) is mapped to the cube Cu9, (3,2,1) is mapped to the cube Cu8, (3,1,1) is mapped to the cube Cu7, (2,1,1) is mapped to the cube Cu4, and (2,2,1) is mapped to the cube Cu5. A similar relationship is established because the second tier A2 and the third tier A3 rotate about the same axis.

In the first tier B1 about the axis B, (1,1,3) is mapped to the cube Cu19, (1,1,2) is mapped to the cube Cu10, (1,1,1) is mapped to the cube Cu1, (2,1,1) is mapped to the cube Cu4, (3,1,1) is mapped to the cube Cu7, (3,1,2) is mapped to the cube Cu16, (3,1,3) is mapped to the cube Cu25, (2,1,3) is mapped to the cube Cu22, and (2,1,2) is mapped to the cube Cu13. A similar relationship is established because the second tier B2 and the third tier B3 rotate about the same axis.

In the first tier C1 about the axis C, (1,1,3) is mapped to the cube Cu19, (1,2,3) is mapped to the cube Cu20, (1,3,3) is mapped to the cube Cu21, (1,3,2) is mapped to the cube Cu12, (1,3,1) is mapped to the cube Cu3, (1,2,1) is mapped to the cube Cu2, (1,1,1) is mapped to the cube Cu1, (1,1,2) is mapped to the cube Cu10, and (1,2,2) is mapped to the cube Cu11. A similar relationship is established because the second tier C2 and the third tier C3 rotate about the same axis.

If the virtual geometric structure 7 is rotated about the A axis counterclockwise by one pitch as illustrated in FIG. 6 (in a first rotation), an initial address (1,1,1) mapped to a reference cube Cu, such as the cube Cu1, is withdrawn. And then an address (1,1,1) is set as a shift address corresponding to an initial address (1,2,1) mapped to the cube Cu2. The cubes Cu are successively shifted by one address and then a shift address (3,1,1) is set for an initial address (2,1,1) mapped to the cube Cu4. Finally, a shift address (2,1,1) is set for the first withdrawn initial address (1,1,1) mapped to the cube Cu1. In the address shifting through the rotation, an address newly shifted at each rotation (shift address) is tracked by calculating an address change relationship of the addresses in FIG. 6. The address conversion unit 3021 successively stores pairs of initial addresses and shift addresses for the cubes Cu in practice. Each time a next rotation instruction is placed, an immediately preceding address is converted to a new shift address (subsequent to shifting).

As seen in FIG. 6, the cube positioned at an address, for example, an address (1,1,1) rotates about each of the A axis, the B axis, and the C axis. With respect to the position immediately preceding the rotation about a given axis, all the addresses of the cubes Cu other than cubes Cu5, Cu14, and Cu23 may be shifted about the axis A, all the addresses of the cubes Cu other than cubes Cu13, Cu14, and Cu15 may be shifted about the axis B, and all the addresses of the cubes Cu other than cubes Cu11, Cu14, and Cu17 may be shifted about the axis C. If the virtual geometric structure 7 is rotated in a variety of fashions about each axis, the initial addresses are significantly scrambled. A scrambling rule is the order of selection of the rotation axes of the virtual geometric structure 7 and the direction of rotation and an amount of rotation at each rotation axis of the virtual geometric structure 7 (an amount of rotation of one cube is referred to as 1 pitch, and one rotation is 8 pitches corresponding to the eight cubes along the external side of the tier (=4(n−1); n=3)). The scrambling rule may be formulated such that a plurality of tiers is rotated if a rotation axis is selected. For example, in one embodiment, the first tier A1 is rotated counterclockwise about the A axis by 1 pitch and the third tier A3 is rotated clockwise about the A axis by 2 pitches.

The scrambling unit 3023 references the shift address in each cube Cu after the rotation process is performed in accordance with the scrambling rule, and re-arranges the cubes Cu in accordance with the shift addresses and the initial addresses. More specifically, the scrambling unit 3023 specifies the cube Cu in accordance with the order of the shift addresses, reads the information unit D pre-mapped to the specified cube Cu, and re-arranges the information unit D in a sequence. Transmission is performed in accordance with the sequence.

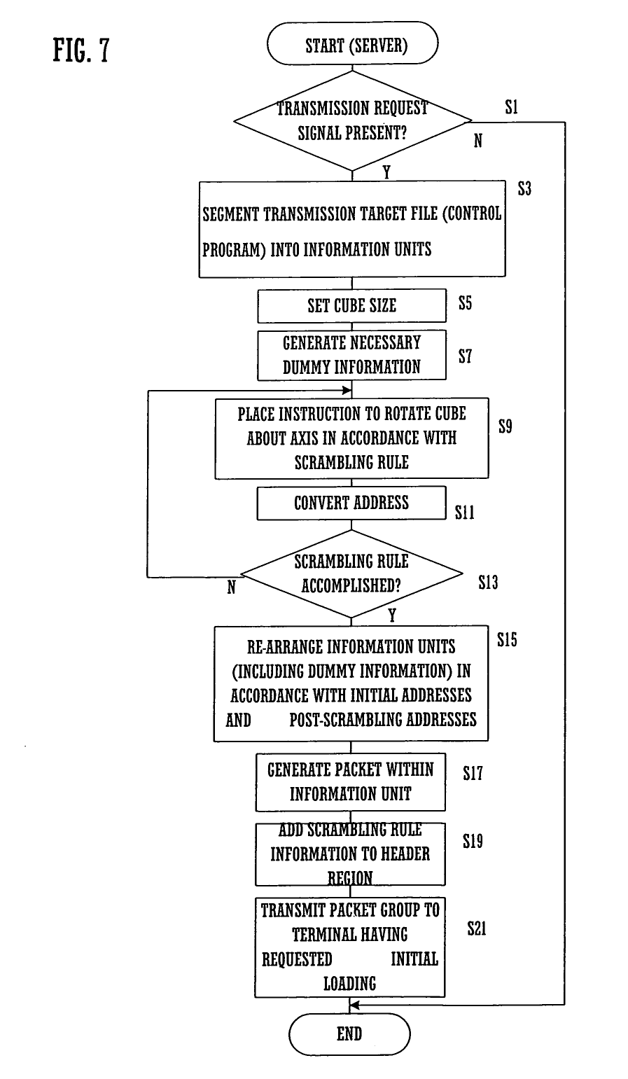

FIG. 7 is a flowchart of the startup process executed by the controller 30 in the management server 3. Referring to FIG. 7, the controller 30 determines whether the transmission request signal has been received from the terminal 1 (or from the terminal 2) (step S1). If no transmission request signal has been received, processing exits the main flow of the startup process. If a transmission request signal has been received, the encryption processor 302 performs a segmentation process (see FIG. 4A) on the information units D of a transmission target file (control program)(step S3). The information units D are segmented by a predetermined bit unit. If the number of segmented information units D is 27 or less, the virtual geometric structure 7 having three elements (cubes) arranged in each axis as illustrated in FIGS. 4-6 is used.

If the number of segmented information units D is above 27 but equal to or less than 64, the virtual geometric structure having four elements (cubes) arranged in each axis is used. More specifically, the size adjusting unit 3024 uses the virtual geometric structure 7 having as the number of cubes in each axis the cubic root of the number of information units D (step S5). Necessary dummy information is generated (step S7). If the number of information units D is 25 with the number of cubes Cu being 27, two pieces of dummy information is generated, and a total number of information units becomes equal to the number of cubes Cu. The two pieces of dummy information is the necessary dummy information. The dummy information may include information that identifies the dummy information. The dummy information is thus removed after being decrypted at the receiver side.

The controller 30 places an instruction to cause the virtual geometric structure 7 to rotate about the axis in accordance with the scrambling rule (step S9). The scrambling rule is stored on the encryption program storage unit 313, and is then read and executed by the encryption processor 302. A variety of scrambling rules are prepared. One of the scrambling rules may be selected and executed. Alternatively, the scrambling rule may be generated at random in each time of need. Preferably, the scrambling rule may instruct the rotation to be performed at least on all the three axes. The rotation instruction may be placed repeatedly on the same axis with a different axis used therebetween in order to result in a high degree of scramble. For example, according to one scrambling rule, the rotation instruction is given on the A axis and the B axis in that order, and the rotation instruction may be given on the A axis again. Preferably, the scrambling rule may include at least three rotations including the rotation instruction for each of the axes. A maximum number of instructed rotations may be set depending on the scramble state determined by the rotation pitch and the like. In one embodiment, a different number of instructed rotations and a different amount of rotation pitch may be set each time of the encryption process.

The address conversion process is executed in response to the rotation (step S11). The address conversion process is performed through calculation as illustrated in FIG. 6 (in accordance with a calculation equation formulated beforehand), in other words, the virtual geometric structure 7 and the cubes Cu are virtually treated. The controller 30 determines whether the rotation instruction defined by the scrambling rule has been accomplished (step S13). If the rotation instruction has not been accomplished, processing returns to step S9 to place a next rotation instruction.

If the rotation instruction has been accomplished, the controller 30 re-arranges the information units (including the dummy information) D in accordance with the initial address and the address subsequent to scrambling (final shift address) (step S15).

Prior to the rotation instruction, the virtual geometric structure 7 is read in the order of the first tier A1 cubes Cu2, Cu3, Cu4, . . . Cu8, and Cu9, the second tier A2 cubes Cu10, Cu11, . . . Cu18, and the third tier A3 cubes Cu19, Cu20, . . . Cu27 in that order, in other words in the order of information units D1, D2, . . . D27 (without being scrambled). Subsequent to the scrambling, the virtual geometric structure 7 is read in the order of the addresses subsequent to the scrambling (final shift addresses). For example, the cube Cu8 having an initial address (3,2,1) may have a shift address (1,1,1) subsequent to the scrambling. The information unit D8 to be read for the eighth time prior to the scrambling is read first subsequent to the scrambling.

Each information unit is converted into a packet (step S17). The packet is preferably generated in accordance with a predetermined communication standard, typically TCP/IP standard, and has a predetermined number of bits. If the information unit D has the predetermined number of bits, one information unit D is one packet. In one embodiment, one information unit may be split into two, or a predetermined number of packets depending on the number of bits included in one information unit D.

The key information attaching unit 3025 attaches information of the scrambling rule to a header region of a leading packet out of the generated packets (step S19). In one embodiment where one of the prepared scrambling rules is selected, information of the scrambling rule may be information identifying the scrambling rule, for example, a serial number. If the information is the scrambling rule itself, information of the number of pieces equal to the number of rotation instructions (the rotation axis, the tier of cubes, the rotation direction, and the rotation pitch) is generated. In one embodiment, the rotation direction is limited to one direction only, and the tiers are limited to the first tier. In such a case, at least (the rotation axis and the rotation pitch) are simply included. For example, if the scrambling rule is “the A axis by one pitch, the B axis by 2 pitches, the C axis by 3 pitches, and the A axis by 4 pitches,” information may be “A1, B2, C3, and A4.”

A generated packet group is transmitted to the member terminal 1 having placed the transmission request (step S21). In one embodiment, the control program may partially include a program assisting the member terminal 1 as a target to start up. The control program may be a program that executes a predetermined process including the above-described file production and file exchanging subsequent to the startup.

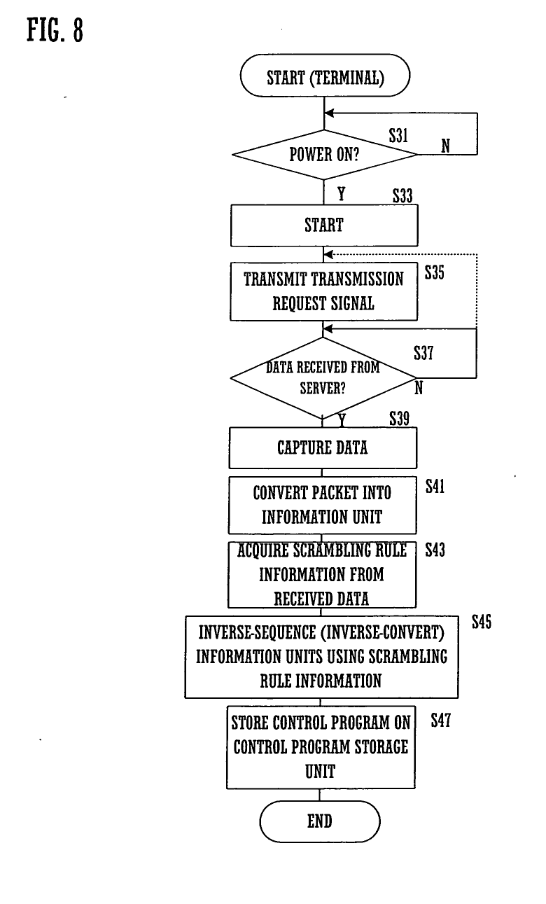

FIG. 8 is a flowchart of a startup process executed by the controller 100 in the terminal 1. As illustrated in FIG. 8, the controller 100 determines whether the terminal 1 has been powered on (step S31). If the terminal 1 has been powered on, the startup processor unit 102 reads a startup program from the startup program storage unit 113 and initiates the startup process (step S33).

During the startup process, a transmission request signal is generated and transmitted to the management server 3 (step S35). The controller 100 then determines whether data has been received in response to the transmission request signal (step S37). If no data has been received, the controller 100 waits on standby for data. Alternatively, the transmission request signal is transmitted again or by a predetermined number of times as denoted by a broken line. The received data results from segmenting the control program discussed with reference to FIG. 7, and converting the segmented program into the packet group.

The received data is temporarily stored on the storage 110 (step S39), and the packets forming the data are converted back to the information units D (step S41). The controller 100 then acquires scrambling rule information from the header region of a predetermined packet of the information unit of the received data (step S43). Using the acquired scrambling rule information, the controller 100 then performs an inverse sequencing process, i.e., inverse conversion (decryption process) on the information units (step S45). The decrypted control program is stored on the control program storage unit 114 (S47). In one embodiment, in step S39 and subsequent steps, the packets in the received state thereof are re-arranged (decrypted) by acquiring the scrambling rule information from the header region, and each packet may be converted back to the information unit.

The invention also includes the following embodiments.

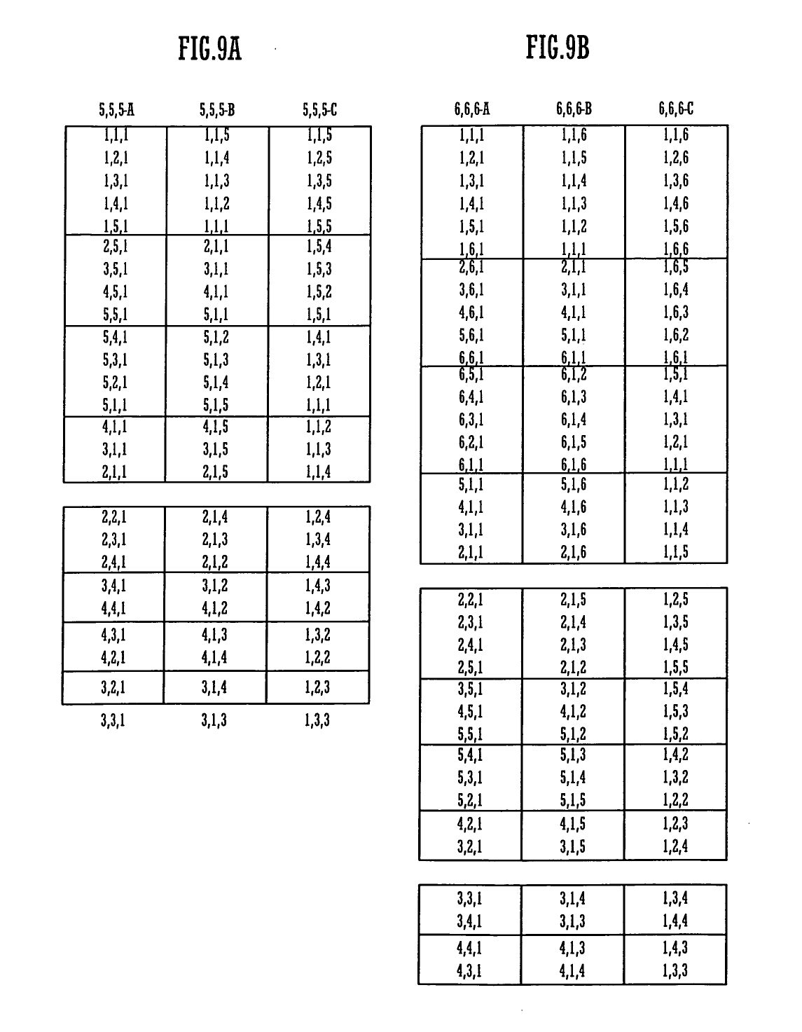

(1) The embodiment is not limited to information transmission via the dedicated network 6, and is applicable to information transmitted via the Internet 5.
(2) FIG. 9 illustrate the shift characteristics of the addresses shifting in response to the rotation of the cubes in another embodiment. FIG. 9A illustrates the shift characteristics with n being 5, and FIG. 9B illustrates the shift characteristics with n being 6. In the same manner as in FIG. 4, the reading order of the information units from the first row to the last row is set on the cubes Cu1-Cu125 of FIG. 9A and on the cubes Cu1-Cu216 of FIG. 9B, starting with the top left cube Cu1 on the first row toward the bottom right cube.

As illustrated in FIG. 9A, the reading order about the A axis listed at [5,5,5,−A] on the first tier A1 is addresses (1,1,1), (1,2,1) . . . (2,1,1) on the outer side of the first tier A1, followed by (2,2,1) . . . (3,2,1) on the inner side of the first tier A1, and then (3,3,1) at the center of the first tier A1. These addresses correspond to cubes Cu1, Cu2, . . . Cu6, Cu1, . . . Cu12, and Cu13. In the embodiment, the addresses of the cubes Cu are successively shifted from the outer to inner side about the rotation axis, in other words, shifted in a spiral fashion. The reading order of the second tier A2, . . . , the fifth tier A5 are similar because these are also rotated about the same axis as that of the first tier A1. Similarly, the reading order is also spirally shifted about the B axis and the C axis as labeled with [5,5,5,−B] and [5,5,5,−C]. The center is the cube Cu13. If viewed from the A axis, the B axis, and the C axis, a change in the addresses follows a certain relationship, and the shifting of the addresses is calculated by making use of the change.

As illustrated in FIG. 9B, the reading order about the A axis listed at [6,6,6,−A] on the first tier A1 is addresses (1,1,1), (1,2,1) . . . (2,1,1) on the outer side of the first tier A1, followed by (2,2,1) . . . (3,2,1) on the inner side of the first tier A1, then further inside (3,3,1), and finally (4,3,1) of the first tier A1. These addresses correspond to cubes Cu1, Cu2, . . . Cu6, Cu7, . . . Cu14, Cu15, . . . Cu21. In the embodiment, the addresses of the cubes Cu are successively shifted from the outer to inner side about the rotation axis, in other words, shifted in a spiral fashion. The reading orders of the second tier A2, . . . , the sixth tier A6 are similar because these are also rotated about the same axis as that of the first tier A1. Similarly, the reading order is also spirally shifted about the B axis and the C axis as labeled with [6,6,6,−B] and [6,6,6,−C]. The center is in the middle of cubes Cu15, Cu16, Cu21, and Cu22. If viewed from the A axis, the B axis, and the C axis, a change in the addresses follows a certain relationship, and the shifting of the addresses is calculated by making use of the change. The value n may be n=2, n=4, or n=7 or larger. If n is an odd number, the center of rotation is aligned with the center cube Cu, and the calculation of the address shifting is easy.

(3) In the discussion of the invention, each scrambled packet is transmitted as is. The present invention is not limited to this arrangement. Any known encryption process may be performed on the packet.

As described above, an information processing apparatus of the invention for transmitting encrypted information via a network, preferably includes a virtual geometric structure including a virtual three-dimensional body having n tiers of elements in each axis direction, each element rotatable about a central axis in each axis direction with an initial address set in each element prior to rotation, the initial address being successively shifted in a spiral fashion in response to the rotation of the element about the central axis, an address conversion unit for rotating the virtual geometric structure successively about each of the central axes in accordance with a predetermined scrambling rule with a pitch of an integer multiple of ¼(n−1) and calculating a final address responsive to each of the initial addresses subsequent to the shifting, an information segmentation unit for segmenting transmission target information into a plurality of information units, and a scrambling unit for re-arranging, prior to the transmission, a sequence of the information units in accordance with the order of the final addresses, instead of the initial addresses assigned prior to the rotation.

According to the invention, the virtual geometric structure is used. The virtual geometric structure includes the virtual three-dimensional body having n tiers of elements in each axis direction. Each element is rotatable about the central axis in each axis direction with an initial address set in each element prior to the rotation. The initial address is successively shifted in a spiral fashion in response to the rotation of the element about the central axis. The address conversion unit rotates the virtual geometric structure successively about each of the central axes in accordance with a predetermined scrambling rule with a pitch of an integer multiple of ¼(n−1) and calculates the final address responsive to each of the initial addresses subsequent to the shifting. The segmentation unit segments the transmission target information into the plurality of information units. The scrambling unit re-arranges, prior to the transmission, the sequence of the information units in accordance with the order of the final addresses, instead of the initial addresses assigned prior to the rotation. The address as a scrambling target is scrambled through calculation, and the transmission target information is segmented and rearranged in accordance with scrambling results at the transmission of the transmission target. The transmission target information is simply and easily encrypted.

The predetermined scrambling rule may preferably include specifying a rotation pitch to be set on a plurality of tiers out of the n tiers in the axis direction. With this arrangement, the scrambling is performed with a plurality of different pitches about an axis, and with different rotation directions. The scrambling efficiency about an axis is increased.

The predetermined scrambling rule may preferably include specifying at least a type of the central axis, and the rotation pitch. With the type of the central axis and the rotation pitch included as a minimum requirement, the scrambling process becomes effective.

The predetermined scrambling rule may preferably include specifying the same central axis twice with at least another central axis specified between the specifications of the same central axis. The scrambling process is performed with same central axis repeated twice but with the other central axis used therebetween. The scrambling process becomes powerful and a high scrambling efficiency is achieved.

The value n may preferably be an odd number of 3 or larger. With this arrangement, the larger the number of elements, the higher the scrambling efficiency becomes. If the value is an odd number, an element may be placed in the center of rotation. The calculation of the address conversion of the elements in response to the rotation becomes easy.

The information segmentation unit may preferably generate dummy information of the number equal to a difference between n³ as the number of elements and the number of information units, and include the dummy information in the information units. This arrangement leaves no empty space in the transmission information, thereby increasing an amount of scrambled information. The chance of unlawful reading is thus reduced.

The information unit may preferably be identical in size to a transmission packet. With this arrangement, the information unit is packetized as is, and information processing is facilitated.

The information processing apparatus may preferably further include a size adjusting unit for adjusting the value n of the virtual geometric structure in accordance with the number of information units. With this arrangement, the value n is different depending on the amount of the transmission target information (an integer value as a cubic root). The size (the value n) of the virtual geometric structure is adjusted taking into consideration the amount of information.

The information processing apparatus may preferably further include a key information attaching unit for including the predetermined scrambling rule in a predetermined one of information units. With this arrangement, the scrambled information may be embedded at an appropriate location in the transmission information and the receiver side may decrypt the received information. In one embodiment, the scrambling process is performed with one of the plurality of prepared scrambling rules selected. Information identifying the scrambling rule is simply transmitted. The chance of information leak is thus reduced.

The transmission target information may preferably be a control program. This arrangement reduces the chance at which the control program is stolen from the transmitter side apparatus.

### INDUSTRIAL APPLICABILITY

The invention includes the virtual geometric structure including the virtual three-dimensional body having n tiers of elements in each axis direction, each element rotatable about the central axis in each axis direction with the initial address set in each element prior to rotation, the initial address being successively shifted in the spiral fashion in response to the rotation of the element about the central axis. The address conversion unit rotates the virtual geometric structure and calculates the final address responsive to each of the initial addresses subsequent to the shifting. The segmentation unit segments the transmission target information into the plurality of information units. The scrambling unit re-arranges, prior to the transmission, the sequence of the information units in accordance with the order of the final addresses, instead of the initial addresses. The scrambling process is preformed through calculation, the transmission target information is re-arranged in accordance with scrambling results at the transmission. The encrypted information is simply and easily transmitted.

1. An information processing apparatus for transmitting encrypted information via a network, comprising:
a virtual geometric structure including a virtual three-dimensional body having n tiers of elements in each axis direction, each element rotatable about a central axis in each axis direction with an initial address set in each element prior to rotation, the initial address being successively shifted in a spiral fashion in response to the rotation of the element about the central axis;
an address conversion unit for rotating the virtual geometric structure successively about each of the central axes in accordance with a predetermined scrambling rule with a pitch of an integer multiple of ¼(n−1) and calculating a final address responsive to each of the initial addresses subsequent to the shifting;
an information segmentation unit for segmenting transmission target information into a plurality of information units; and
a scrambling unit for re-arranging, prior to the transmission, a sequence of the information units in accordance with the order of the final addresses, instead of the initial addresses assigned prior to the rotation.

2. The information processing apparatus according to claim 1, wherein the predetermined scrambling rule includes specifying a rotation pitch to be set on a plurality of tiers out of the n tiers in the axis direction.

3. The information processing apparatus according to claim 1, wherein the predetermined scrambling rule includes specifying at least a type of the central axis, and the rotation pitch.

4. The information processing apparatus according to claim 1, wherein the predetermined scrambling rule includes specifying the same central axis twice with at least another central axis specified between the specifications of the same central axis.

5. The information processing apparatus according to claim 1, wherein the value n is an odd number of 3 or larger.

6. The information processing apparatus according to claim 1, wherein the information segmentation unit generates dummy information of the number equal to a difference between n³ as the number of elements and the number of information units.

7. The information processing apparatus according to claim 1, wherein the information unit is identical in size to a transmission packet.

8. The information processing apparatus according to claim 1, further comprising a size adjusting unit for adjusting the value n of the virtual geometric structure in accordance with the number of information units.

9. The information processing apparatus according to claim 1, further comprising a key information attaching unit for including the predetermined scrambling rule in a predetermined one of information units.

10. The information processing apparatus according to claim 1, wherein the transmission target information is a control program.

11. A transmission information encryption method for encrypting information to be transmitted via a network, comprising:
a step of preparing a virtual geometric structure including a virtual three-dimensional body having n tiers of elements in each axis direction, each element rotatable about a central axis in each axis direction with an initial address set in each element prior to rotation, the initial address being successively shifted in a spiral fashion in response to the rotation of the element about the central axis;
a step of rotating the virtual geometric structure successively about each of the central axes in accordance with a predetermined scrambling rule with a pitch of an integer multiple of ¼(n−1) and calculating a final address responsive to each of the initial addresses subsequent to the shifting;
a step of segmenting transmission target information into a plurality of information units; and
a step of re-arranging, prior to the transmission, a sequence of the information units in accordance with the order of the final addresses, instead of the initial addresses assigned prior to the rotation.

12. A transmission information encryption program for causing a computer to encrypt information to be transmitted via a network, the program causing the computer to operate as:
address conversion unit for rotating a virtual geometric structure successively about each central axis in accordance with a predetermined scrambling rule with a pitch of an integer multiple of ¼(n−1) and calculating a final address responsive to each initial address subsequent to shifting, the virtual geometric structure including a virtual three-dimensional body having n tiers of elements in each axis direction, each element rotatable about a central axis in each axis direction with an initial address set in each element prior to rotation, the initial address being successively shifted in a spiral fashion in response to the rotation of the element about the central axis;
segmentation unit for segmenting transmission target information into a plurality of information units; and scrambling unit for re-arranging, prior to transmission, a sequence of the information units in accordance with the order of the final addresses, instead of the initial addresses assigned prior to the rotation.
